(19) United States
(12) Patent Application Publication
(10) Pub. No.: US 2020/0299805 A1
(43) Pub. Date: Sep. 24, 2020

(54) METHOD AND APPARATUS FOR THE TREATMENT OF WATER WITH THE RECOVERY OF METALS

(71) Applicant: PURLUCID TREATMENT SOLUTIONS (CANADA) INC., Calgary (CA)

(72) Inventors: PRESTON MERSHON MCEACHERN, Calgary (CA); NORMAN WONG, Calgary (CA); MARIO ANDRIC, Calgary (CA)

(21) Appl. No.: 16/624,744

(22) PCT Filed: Jun. 27, 2018
(86) PCT No.: PCT/CA2018/050795

§ 371 Date: Dec. 19, 2019

Related U.S. Application Data
(60) Provisional application No. 62/525,361, filed on Jun. 27, 2017.

(51) Int. Cl. C22B 26/12; C01D 15/00; B01J 20/06; B01J 20/26; B01J 20/18; B01J 20/28; B01J 20/282; B01J 20/34; C22B 7/00; C02F 9/00

(52) U.S. Cl. CPC C22B 26/12; C01D 15/00; B01J 20/06; B01J 20/261; B01J 20/18; C02F 1/281; B01J 20/282; B01J 20/3475; B01J 20/3433; C22B 7/007; C02F 9/00; B01J 20/28026

(57) ABSTRACT

A method of recovering lithium from energy process water includes the steps of: removing alkaline earth metals from the water; passing the treated water through a reactor column containing a titanium oxide molecular sieve that adsorbs lithium ions; eluting the lithium ions from the molecular sieve using a strong acid solution; and collecting the resulting lithium-rich eluate fluid from the reactor column. The reactor column may include a diffuser core at the inlet tapered from a wider base to a narrow inner end as well as a first screen through which the fluid flows. Fluid exits the inner volume of the column through an outlet tube including a mounted end and walls that taper from the mounted end to a narrower tip; the walls include a second screen through which the fluid flows.

### TECHNICAL FIELD

The invention relates to recovery of lithium from water. In particular, recovery of lithium from saline wastewater.

### BACKGROUND

Produced water and wastewaters are produced in large volumes annually throughout the hydrocarbon and power production industries and are a considerable logistical and environmental liability for the companies producing them. For simplicity, the collective waters from the oil and gas industries are termed hydrocarbon produced waters because they contain substantive concentrations of hydrocarbon-related organic compounds that both distinguish them from other waters typically considered as sources for metal recovery (e.g. geologic brines) and make existing methods of metal recovery from these waters difficult.

### SUMMARY

In accordance with a broad aspect of the present invention, there is provided a method of recovering lithium from energy process water, comprising: removing alkaline earth metals from the water to form a treated water; passing the treated water through a reactor column to contact the treated water with a titanium oxide molecular sieve to adsorb lithium ions in the molecular sieve; draining the treated water from the reactor column while the molecular sieve remains in the reactor column; eluting the lithium ions from the molecular sieve using a strong acid solution to desorb the lithium ions into an eluate fluid; and collecting the eluate fluid from the reactor column, the eluate fluid being rich with lithium ions.

In accordance with a broad aspect of the present invention, there is provided an apparatus for recovering lithium from energy process water, comprising: a system for removing alkaline earth metals from the water to form a treated water; a reactor for removing the lithium ions from the treated water, the reactor including at least one column, the column including: an inlet; an outlet; a diffuser core at the inlet through which fluid flows from the inlet into an inner volume of the column, the diffuser core tapered from a wider base to a narrow inner end and the diffuser core including a first screen through which the fluid flows; an outlet tube at the outlet through which fluid exits the inner volume of the column, the outlet tube including a mounted end, a narrower tip and walls that taper from the mounted end to the narrower tip, the walls including a second screen through which the fluid flows; and a titanium oxide molecular sieve configured to adsorb lithium ions, the titanium oxide molecular sieve retained in the inner volume between the diffuser core and the outlet tube and having a size unable to pass through the second screen; an eluting system configured to contact the molecular sieve with a strong acid solution to desorb lithium ions into an eluate fluid; and a collecting system to collect the eluate fluid, the eluate fluid being rich with lithium ions.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 is a schematic depiction of water production from oil and gas wells (upstream oil and gas) and wastewaters from hydrocarbon processing such as refineries or upgraders (downstream oil and gas), collectively termed hydrocarbon produced water or HPW with transfer to a facility that provides treatment allowing reclamation of water as a resource for reuse or alternate use.

FIG. 2 is a schematic depiction of a water treatment system that incorporates lithium recovery.

FIG. 3 is a schematic depiction of a water treatment system.

FIG. 4a is a schematic depiction of an adsorption/elution column.

FIG. 4b is a schematic depiction of an adsorption/elution assembly.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

An economical water treatment method is described that makes a portion of the water reusable while also extracting lithium during the treatment process.

The invention relates to recovery of lithium from water. In particular, recovery of lithium from saline wastewater. The preferred embodiments focus on two source water types that represent significant water treatment and mineral recovery challenges; produced or wastewaters from the oil and gas industry and fluids from energy production, particularly geothermal power production. Both sources contain high concentrations of mineral ions (silica, calcium, magnesium, sodium, potassium and other alkaline earth and metal constituents in lesser quantities) making lithium recovery exceedingly difficult using other technologies. In the preferred embodiment, the system can pre-treat and recover lithium from saline water containing organic constituents present from hydrocarbon processing at temperatures from 5 to 200° C. and can, at the higher temperatures, recover lithium from power production facilities without cooling.

Particular embodiments, provide methods and systems for water treatment of hydrocarbon produced water such that these components are removed making them suitable for recovery of lithium. In the geothermal industry, condensate and low temperature steam is often returned to the reservoir or used in domestic heating. However, subsequent cooling in the injection or distribution systems creates intense scaling of infrastructure. For simplicity, these waters are termed high temperature power production waters and are distinguished from geologic brines and other concentrates by having a temperature above 100° C. High temperature removal of alkaline earth minerals such as calcium and magnesium as well as silica is an imperative that has yet to be achieved at reasonable cost and process simplicity and has not been achieved for lithium recovery. In the preferred embodiment, we both pre-treat geothermal waters for their subsequent return or use and we extract lithium at the delivered temperature which is typically above 100° C.

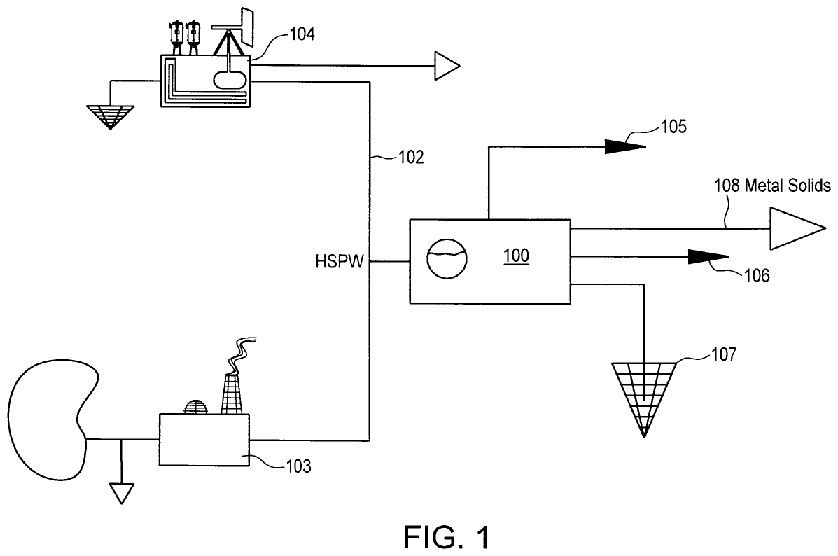

FIG. 1 shows an example HPW treatment and lithium recovery system 100 which may receive fluids 102 from facilities 103 for extraction of oil, including heavy crude oil, bitumen and/or the like and natural gas and may include other industrial sources 104. When the water handling facility provides treatment functions it can be formulated to include recovery of lithium as well as alkaline earth hydroxides and carbonates as marketable products 108 as a component of, or accessory to, treatment of the water for use 105, discharge 106, or disposal 107. System water input can come from any number of sources as exemplified by FIG. 1 but typically will have a Total Dissolved Solids (TDS) concentration greater than 50,000 mg/L. In the preferred embodiment for HPW, the system is able to receive and operate efficiently even if these waters are mixed with other high TDS waters. In this regard the preferred embodiment is robust and can operate across a range of high salinity feed waters and a range of temperatures, particularly those above 100° C. To set these geologic-sourced energy produced waters apart distinctively from other commercial lithium recovery sources, the waters are collectively referred to as high salinity produced water (HSPW) with respect to the oil and gas industry and high temperature power-production water (HTPW) with respect to recovery of lithium from geothermal brines and industrial concentrates without cooling.

The chemical character of HSPW and HTPW is a result of contact with a subsurface geologic formation, as is the case in oil and gas produced water and geothermal brines, or as a result of chemical additions and/or concentration through evaporative or membrane systems, as is the case with downstream processing or other industrial sources. As is known in the art, HSPW often contains concentrations of free and emulsified oil, organic acids and other complex organics derived from oil and gas extraction. These organic compounds eliminate the possibility of using other known technologies for lithium recovery because they foul membranes, electrodialysis systems and evaporators. HSPW and HTPW also contain high concentrations of metal and alkaline earth elements that make further use of the water difficult without the water treatment systems and lithium recovery system of the preferred embodiment presented herein. Lithium recovery is further complicated when high concentrations of metal and alkaline earth elements are present in combination with organics. In current practice, these problematic waters are typically injected into an underground disposal well or cavern 107 because they cannot be used unless they are treated. In addition, treatment of these waters may be prohibitively expensive, an issue that is overcome in the present invention by the method and the recovery of lithium during the treatment process to offset treatment costs.

The recovery of minerals from water is a well-developed field. Indeed, most mineral recovery techniques in the mining industry rely on a sequence of steps termed valuable mineral recovery. In hard rock mining, ores are processed to a size suitable for concentration and may or may not use an aqueous solution. Solution mining typically uses an aqueous approach as the valuable minerals are dissolved in water. Concentration relies on the chemical and physical properties of the mineral compared to the undesirable minerals also in the feedstock. This undesirable material is called “gangue” and the separation of a target mineral from gangue is of great interest. Concentration processes do not require an aqueous solution, however, the use of water in these processes is common and is typically required for phase separation. Concentration processes include gravimetric, magnetic, electrostatic and flotation systems but these processes are not mutually exclusive. For example, phase separation can deploy chemical processes that make subsequent gravimetric, magnetic, flotation, and filtration processes possible.

Taking for example, the recovery of lithium from brines, several US patents have been issued utilizing chemical adsorbents to generate a lithium rich solid that is then recovered by filtration or gravity separation. U.S. Pat. No. 3,306,700 (1967) utilized a hydrated aluminate in solution to create a lithium aluminate solid that is then recovered gravimetrically or by filtration. A derivative of this approach to mineral separation and concentration applies an electrical field to attract ions to an opposingly charged surface such as an anode or a charged surface protected by a semi-permeable membrane as in membrane electrodialysis wherein the charge is delivered to the surface electrically.

Those skilled in the field have routinely deployed molecular sieves for metal recovery. Taking for example, the recovery of lithium from brines, several US patents have been approved utilizing molecular sieves or their precursors generically referred to as adsorbents. U.S. Pat. No. 4,348,295 (1982) developed a hydrated aluminate solid matrix termed an ion exchange resin which is functionally a molecular sieve. Subsequent developments including U.S. Pat. No. 6,280,693B1 (2001) continued to develop these aluminate molecular sieves. More recently, patents such as U.S. Pat. No. 8,741,256 (2014) have added details to the process for conditioning water prior to deployment of molecular sieves but continue to use aluminate-based adsorbents. Unfortunately, aluminate-based adsorbents have proven to be inefficient with recoveries typically below 60%.

Even the most selective molecular sieves adsorb undesirable minerals from the gangue. Commercial deployment of molecular sieves in mineral recovery has been hampered by the cost of conditioning feedstock to remove these contaminants and few, if any, have been able to function over commercially required cycles when high levels of organic compounds have been present. For example, it is believed that commercial recovery of lithium utilizing a molecular sieve is hampered due to the challenges of removing silica, magnesium, calcium and other metals that contaminate the lithium product. Methods using of adsorbents of the aluminate, manganese or titanium type must also focus on a means for removal of contaminating ions. For waters derived from the hydrocarbon industry, free and dissolved organic constituents including oil, organic acids and polycyclic aromatic hydrocarbons (PAHs) will contaminate adsorbents and are particularly detrimental to molecular sieve matrices. Complete contamination and loss of absorbency can occur in a single cycle if not removed prior to the adsorption phase. No solutions to date provide a means of removing hydrocarbon related contaminants within a single process for subsequent metal recovery prior to utilizing adsorbents. When utilizing HTPW, all waters must be cooled below boiling temperatures to implement existing technologies.

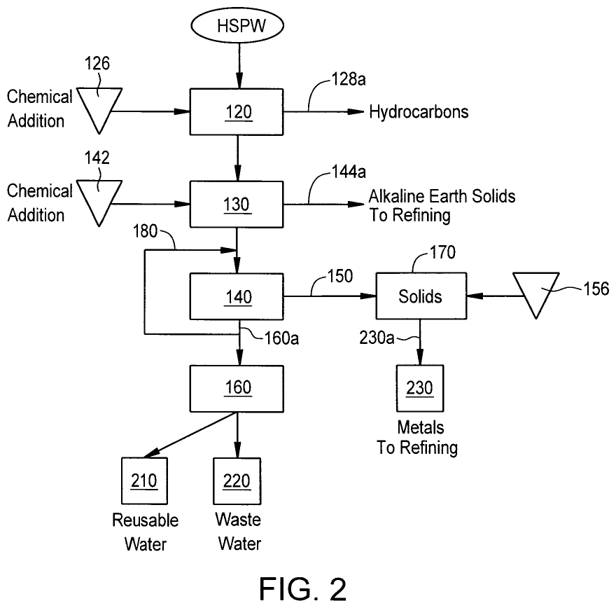

Aspects of the invention provide systems and methods for lithium recovery from energy process waters such as those produced by the hydrocarbon industry or the geothermal industry, where the treatment allows recovery of water and lithium as practical resources. FIG. 2 provides an overview of some embodiments where substantially all of the water is treated by a process comprising: chemical addition and systems to remove hydrophobic compounds such as oil 120; chemical addition and systems to remove alkaline earth constituents 130; systems 140 to selectively separate specific metals such as lithium from the water, specifically to generate a cleaned water stream 160 and solids 170 that are metal-enriched. With respect to solids 170, the process further includes: a chemical addition 156 for extracting 230a target metals 230 from the solids; reconditioning of spent solids for reuse in metal recovery; and/or possibly disposal of metal depleted solids. With respect to the water, recirculation of the intermediate clean water for additional metal recovery 180; storage of clean water for use 210; disposal or recirculation of residual water that does not meet specifications for use 220. The system for HSPW and HTPW differ in the following regards, HTPW does not require the system for hydrocarbon removal and all of its systems must be built to withstand pressures above 1 bar and typically up to 10 bar. In both cases, water treatment and metal recovery may be incorporated into an industrial water treatment system or stand alone as a complete system.

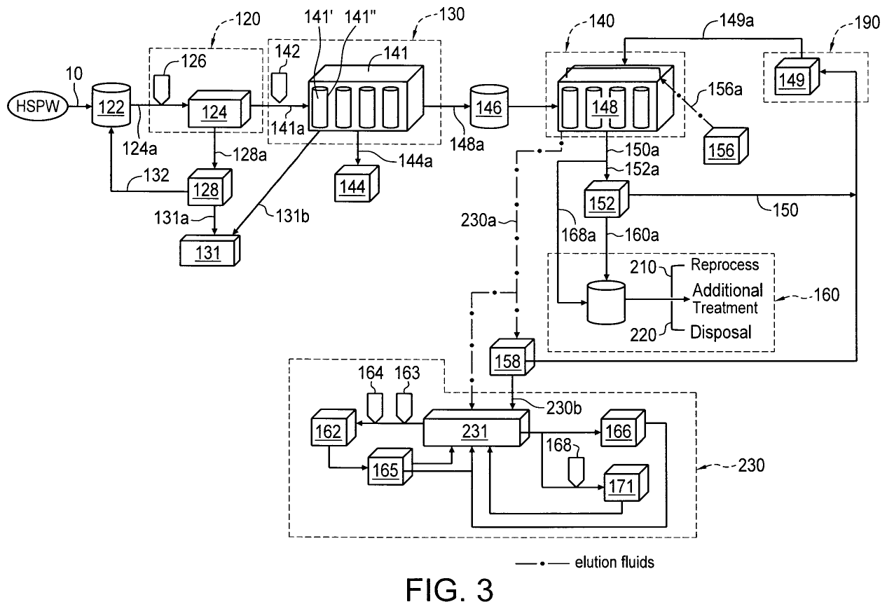

FIG. 3 shows one particular embodiment of the system. The embodiment specifically describes HSPW, but can be applied to HTPW. HSPW to be processed is received 10 and stored in a tank or similar vessel 122 with sufficient residence time to promote separation of fluid and solid mixtures by density difference. In embodiments where initial density separation is desired, tank 122 can be in many physical formulations that include heat and internal infrastructure to promote more rapid density dependent separation. Examples include what are known in the industry as clarifiers, lamella separators, treaters and other forms where enhanced surface area and/or heat expedited density dependent separation. While common in the industry, residence time for density separation or its enhancements may not be required and are frequently addressed with additional treatment technology such as filters, clarifiers, centripetal separators, and ion exchange systems in any combination or order to achieve a water treatment outcome.

Thereafter, if the HSPW has a high concentration of hydrocarbon contaminants, those contaminants may be removed 120 in a separator 124. Alkaline earth contaminants are removed in a system 130 including a separator 141. In a preferred embodiment of this invention systems 120 and 130 employ an enhanced hydrocarbon and colloid removal technology known as Nanoflotation, as described in US 2013/0270191A1 and WO 2011/123922. As is described further herein below, Nanoflotation reduces residence time in the feed tank/line system and provides an initial treatment outcome suitable for use with HSPW feedstock and integration with subsequent metal recovery. Nanoflotation technology is two proven technologies; a high intensity froth flotation (HiFF) 124 and replaceable skin layer membrane filtration (RSL™) 141.

In one embodiment of the invention, water is fed 124a from tank 122 to system 124, which in this embodiment is a flotation system. Here a substantial portion of the oil and colloidal solids are removed by attaching to bubbles injected into the system. As previously described, the preferred embodiment utilizes the HiFF system for injection prior to either a dissolved air flotation (DAF) or induced gas flotation (IGF) system; both the DAF or the IGF are available from any number of manufacturers. The location of the HiFF system 126 is prior to entry into the flotation system 124 and offers the means to inject chemicals, gas or both to enhance bubble density and efficiency of the flotation system. The combined systems (e.g. HiFF and DAF) remove contaminants such as oil and fine colloidal solids that rise to the surface and are skimmed 128a to a waste tank 128 where they may be consolidated for disposal 131a in a landfill 131. Fluids from consolidating the waste froth may be returned 132 to the process for additional treatment and maximal recovery of water for reuse. The flotation system may not be required in embodiments of the invention where oil concentrations are reasonably low. Silica can be removed, such as by chemical injection and reaction. A system for removal of alkaline earth elements 130 is more important given the inherent salinity of HSPW and HTPW.

Once processed through the chosen flotation system, the water is ready for further processing 141a. At this point HSPW is similar in character to HTPW, containing high concentrations of alkaline earth elements and other metals as well as counter ions that broadly make up the total dissolved solids (TDS) or salinity.

Commercial grade lithium requires a high purity, often exceeding 99% of total cations, therefore the removal of alkaline earth ions is required from any source water in order to recover lithium commercially. In the current invention, we deploy chemical manipulation followed by ultrafiltration to remove dissolved alkaline earth ions. In the preferred embodiment, the chemical pre-treatment step achieves the removal of magnesium to less than 10 ppm, calcium to less than 50 ppm, iron to less than 5 ppm, boron to less than 2 ppm and trace heavy metals to part per billion levels. In addition to accomplishing this strenuous water treatment objective, this invention provides a method for doing so at temperatures above 100° C. making it possible to utilize high salinity water from the geothermal and thermal power industries without cooling the water.

HSPW is sent 141a to system 130 which in the preferred embodiment is RSL™ ultrafiltration. The system removes divalent ions such as magnesium and calcium, as insoluble hydroxides. In the preferred embodiment, a base is introduced at injection point 142 in the appropriate stoichiometric ratio to increase the pH of the HSPW or HTPW to a value between 10 and 12.

Bases such as sodium hydroxide, calcium hydroxide, ammonium hydroxide, lime and sodium carbonate can be used to augment the removal of calcium and magnesium. Above a pH of 10, magnesium, in this example, will form the insoluble magnesium hydroxide. The insoluble hydroxides are subsequently removed in separator 141 from the fluid by gravity or centripetal force, filtration or, as in a preferred embodiment, by using the RSL™ ultrafiltration in system 130. Ultrafiltration achieves the removal of all particles larger than 0.01 micrometers in diameter. Control of the process in 130 may be implemented through the use of a specialized equilibrium model such as LucidChem™ that predicts the appropriate dose and, in combination with the inventions control system, administers the appropriate doses of hydroxide reactants.

As noted above, in a preferred embodiment of this invention systems 120 and 130 employ an enhanced hydrocarbon and colloid removal technology known as Nanoflotation, as described in US 2013/0270191A1 and WO 2011/123922A1 incorporated herein by reference. Nanoflotation reduces residence time in the feed tank/line system and provides an initial treatment outcome suitable for use with HSPW feedstock and integration with subsequent metal recovery. Nanoflotation technology is two proven technologies; a high intensity froth flotation (HiFF) 124 and Replaceable Skin Layer membrane filtration (RSL™) 141. Both technologies use the same effective method to cause colloidal solid destabilization, exploiting Derjaguin, Landau, Vervey, and Overbeek (DLVO) theory and highly charged micro-environments to collapse repulsive forces between ions. Most colloidal solids will not readily separate from water because of the electric double layer (EDL) and hydration characteristics of charged particles increase their stability in suspension. The patented methodology used in the Nanoflotation technology changes the environment around a colloidal solid causing EDL collapse and agglomeration. Agglomeration is driven by van der Waal forces that overcome the diminished repulsive forces of the EDL. This technology greatly improves treatment of a wide range of suspended solids, colloidal solids and nano-particle concentrations. Excellent results have been achieved removing dissolved metals and scaling parameters like iron, barium, silica, calcium, magnesium and manganese. It also provides for high levels of emulsified and dissolved oil removal.

In the preferred embodiment, the HSPW is processed through a dissolved air flotation system (for low temperature applications) or an induced gas flotation system (for high temperature applications) utilizing the HiFF system which is an enhanced froth generator (US20160207792A1 incorporated herein by reference). In this preferred embodiment, the froth is generated using a charged froth generator with an anionic surfactant. Many such surfactants exist on the market, examples include sodium laureth sulfate and other detergents. The froth is injected into the feed line immediately behind a restriction in the flow piping that then rapidly expands, operating on the Venturi principle, which both draws in the surfactant and creates a high sheer turbulent flow that enhances removal of hydrocarbons by froth flotation. The froth can be skimmed off 128a. The HiFF system is not required in the preferred embodiment for HTPW applications, as they tend not to contain hydrocarbons.

For both HSPW and HTPW, the preferred embodiment of system 130 utilizes ultrafiltration to remove alkaline earth and other metals, thereby providing a permeate particularly suitable for lithium recovery. In the preferred embodiment, ultrafiltration employs the RSL™ membrane system which includes one or more membranes 141′ that separate a feed side from an output side. The membrane feed side includes a replaceable skin layer 141″ of charged precoat particles such as activated carbon, metal oxide or other charged granular particles. This ultrafiltration provides water treatment over two phases: (i) a concentration phase driven by repulsion and (ii) EDL collapse and precoat fouling. During the repulsion phase the EDL of the RSL™ causes repulsion of the colloidal solids approaching the skin layer in a similar fashion as standard fixed and attached skin layers on conventional membranes. This repulsion reduces the layering or caking of the solids on the surface of the skin layer. Repelled solids concentrations increase on the feed side and begin to penetrate the RSL™ initiating phase 2, EDL collapse and precoat fouling. One of the major differences between the RSL™ and standard fixed and attached skin layers is this second phase. With standard skin layers on membranes, phase 2 is managed through backwashing and high cross-flow volumes while eventual fouling must be mitigated through shutdown and expensive clean-in-place (CIP) washes. The removable nature of the RSL™ technology allows us to promote fouling in the skin layer for enhanced solids removal and to eliminate energy intensive and inefficient cross-flow and CIP. The highly charged environment within the pore spaces of the RSL™ creates a uniform compressive force that collapses the colloidal EDL, causing agglomeration and attachment to the RSL™ and other colloids through van der Waal attraction with excellent efficiency and flux rates maintained.

The technology provides an effluent similar to other ultrafiltration membrane technologies but requires significantly less energy and capital costs. In addition, the use of the RSL™ increases flux rates on the membrane significantly. This single step process is highly efficient due to the tuned chemistries utilized in the froth generator and for the RSL™ precoat.

A typical brine profile range is provided in Table 1. In the preferred embodiment, contaminants such as emulsified oil, silica and alkaline earth ions are removed by the preferred embodiments of systems 120 and 130, described above, to concentrations suitable for subsequent metal recovery (Table 1).

TABLE 1
Example feed and post-treatment concentrations of contaminants
provided by the preferred embodiments.

| | Total | | Total | Total | Total | Total |
|---|---|---|---|---|---|---|
| | Oil | Emulsified | Si | Ca | Mg | Ba |
| | (mg/L) | Oil (mg/L) | (mg/L) | (mg/L) | (mg/L) | (mg/L) |
| Feed | 20,200 | 10,000 | 20,500 | 71,000 | 106,700 | 5,300 |
| Post Treatment | <1 | <1 | <15 | 97% | <10 | 85% |
| | | | | removal | | removal |
| Notes | 1 | 1 | 1 | 2 | 2 | 1 |

Notes:
1 Highest concentration tested, performance limit not reached. Higher concentration feeds likely suitable,
2 Highest economical concentration tested, higher concentrations result in either degraded product or prohibitive consumable costs.

Alternatives can use standard industrial flotation and filtration systems with turbulent conditions created within the piping from single or multiple static mixers in series to create the requisite reaction and contact time for colloidal growth and destabilization. Similar quality permeate can be obtained by this method but with a loss in efficiency due to slower reaction times, the potential need for seeding and eventual fouling of membrane systems.

The solids from separator 141 may be directed 144a to a system for recovery of alkaline earth minerals 144 of compounds such as magnesium oxide through processes well known to practitioners of the art. In one embodiment, the solids from separator 141 are dried and subsequently heated at 800 C.° until sufficiently calcined for use as slow burn MgO in a number of industrial applications including subsequent water treatment. Otherwise the solids are directed 131b to disposal in a separate system or, for expedience, to landfill 131.

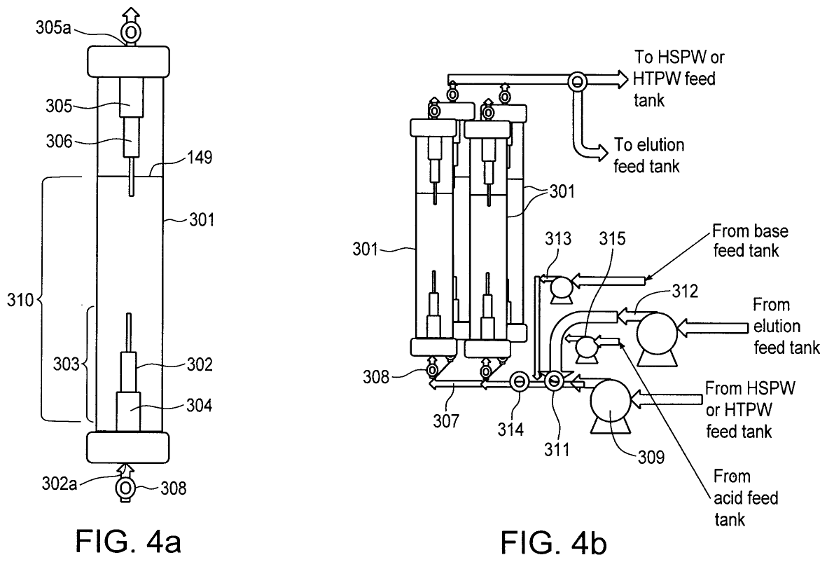

Fluids after initial cation removal 141 are sent 148a to an absorbent reaction system 140 for removal of lithium. In one embodiment, the water from treatments 120, 130 pass into a permeate tank 146 and from there to one or more batch reactors 148 in which the fluids are introduced into contact with an amount, such as a stoichiometric amount, of an adsorbent 149 for separating lithium from the pre-treated water. The metal adsorbent may be in the reactors 148 or may be added 149a along with the fluids and subsequently removed. In the preferred embodiment, the adsorbent is a molecular sieve nanomaterial immobilized in a suitable matrix and placed and intended to remain in one or more vertical columns as an expanded bed reactor. Referring to FIGS. 4a and 4b, the expanded bed reactor 148 includes at least one column 301, such as may be one to two meters in height, with a tapered diffuser core 302 extending from the feed inlet port 302a into the column through which the feed water enters the reactor by way of a pipe with a valve 308 directed from pump 309. The tapered core is typically wider at its base, inlet end and narrows with depth of penetration up into the column. In the preferred embodiment, the diffuser core extends at least 25% into the total column height but not more than 50% of the total length. The purpose of the diffuser is to introduce the fluid uniformly over the bottom section of the reactor 303. The diffuser core 302 includes a screen 304 through which fluid must pass to exit the core and move into the inner volume of the column. Screen 304 has a pore size slightly smaller than the 10^{th} percentile particle size of the adsorbent which acts, along with the hydrostatic pressure of the pump to ensure the adsorbent does not flow backwards into the feed pump system. In the preferred embodiment, the screen has a minimum pore size of 100 micrometers and not more than 1 mm. The remainder of the column contains the adsorbent to a height of approximately 75% of the column height 310. The adsorbent has a d10 particle size of at least 60 micrometers and not more than 2 mm. After flowing upwards through the adsorbent, the water exits the reactor through a collector tube 305 which may also be tapered: having walls that are narrower at the lower end, inner tip facing the diffuser core. The walls diverge such that the core tube widens towards the outlet end where it is connected about the column outlet 305a. The walls of tube 305 include or are formed entirely of a screen through which fluid must pass to exit the inner volume of the column and enter the tube for outlet from the column and from the reactor. The screen 306 on the collector tube has a passage size that is slightly smaller than the minimum size of the adsorbent, so that the adsorbent cannot pass through and is retained by the screen. This is achieved in practice by rinsing the adsorbent during manufacture through the same sized screen or after initial loading to the screen, thereby to remove smaller adsorbent particles that pass through the screen. These smaller particles may be recycled and used in further manufacturing of the adsorbent with the aim to incorporate them into larger adsorbent particles. In the preferred embodiment, the screen 306 has a minimum nominal pore size of 80 micrometers but can be as high as 500 micrometers. By screen, it is intended to mean any type of structure that has passageways for through flow of fluids but where the passageway openings are sized to stop passage of solids larger that the openings. Thus, screen can include perforated planar materials, woven materials, etc.

Adsorbents 149 can be any number of compounds that target metals generally or specifically and are referred to in the industry as chelators (organic molecules introduced as a fluid such as EDTA), cation exchange resins (solid organic compounds such as sulfonated organic copolymers through which the target solution is permeated), ion sieves (solid inorganic minerals such as titanium oxide, manganese oxide or aluminum oxide), and other adsorbents such as activated carbon and its close relative, graphene. This invention can employ various adsorbents, however, preference is for molecular sieves (also sometimes referred to as ion sieves). As will be appreciated, a molecular sieve is a material with pores of substantially uniform size. These pore diameters are similar in size to small molecules, and thus large molecules cannot enter or be adsorbed, while smaller molecules can. As a mixture of molecules migrate through the molecular sieve, stationary bed of porous, semi-solid substance, the components of highest molecular weight (which are unable to pass into the molecular pores) leave the bed first, followed by successively smaller molecules.

In some cases, molecular sieves use the surface-active charge of the material itself to attract and retain the dissolved mineral of interest. These molecular sieves are usually formulated out of the same components as adsorbents, combined with ion exchange principles.

In the preferred embodiment a non-aluminate molecular sieve such as a titanium oxide molecular sieve is utilized. A lithium-targeted titanium oxide (TiO) molecular sieve may be created through a sol-gel process. A lithium targeted TiO can be generated by infiltrating lithium to the TiO matrix and then washing out the lithium. Further calcination at temperatures from 600° C. to 1000° C. is required to form the target intercalated crystals having particle sizes typically less than 100 micrometers. The TiO adsorbent is then fixed in a polyacrylamide matrix for use with HSPW low temperature operations. For HTPW high temperature operations, the TiO adsorbent is then fixed in a zeolite or aerogel matrix. The fixed TiO/matrix creates adsorbent beads in the 1 to 2 mm diameter size range.

The polyacrylamide matrix is formed from acrylamide monomers at approximately 50 weight percent with the TiO adsorbent. This creates a large diameter hydrophilic adsorbent matrix suitable for an expanded bed reactor with rapid diffusion of the feed water into the matrix and contact with the TiO adsorbent.

When fixed as an aerogel or zeolite, a templating method is used to generate the required porosity from monomeric silica and aluminosilicates. The templating method incorporates plastic particles, such as of polystyrene, into the matrix material. The sacrificial plastic particles are later burned out to form the pores.

In order to optimize adsorption, high contact renewal between the adsorbent and the HSPW or HTPW is maintained within each reactor through fluid flow by continuous recirculation pumping. In the preferred embodiment as shown in FIG. 4b, four reactors 301 are attached to a single manifold 307 fed by one pump 309 with feed from a single feed tank to which the water is returned for multiple cycles over the adsorption period. The feed tank can be any size but in the preferred embodiment contains no more volume than can be completely cycled through the reactors in a time of no less than once per hour. A plurality of cycles through reactor 148 improves the recovery. Water may therefore be cycled a plurality of times through a column with one embodiment including a minimum of four complete recycles of the feed tank through the adsorbent. During the adsorption phase, the pH is maintained in the range of pH10 to 11.5. This is accomplished with a chemical injection pump 313 with an inlet prior to or after the recirculation pump 309. The chemical injection pump 313 may inject a base, such as a concentrated base solution such as sodium hydroxide (2 to 5 M) or ammonium hydroxide (2 to 13.5 M) with automatic control to a pH sensor 314 in the recirculation loop.

In the preferred embodiment of the invention shown in FIG. 3, the adsorbent remains in the expanded bed reactor 148, the cleaned water is drained 150a, 168a and sent to handling system 160. While the water in such an embodiment may be passed to a final cleaned water handling system 160, it may contain some residual adsorbent and can alternately be sent 152a to a separator 152 before system 160. In such a system, after separator 152, the separated water is sent 160a to water handling system 160 and the recovered adsorbent is directed 150 to an adsorbant handling system 190.

After the water is drained, an elution fluid 156 that extracts the metal from the adsorption sites on or within the matrix of the adsorbent is introduced 156a to the reactor 148. After the water cycles are complete, therefore, the feed pump 309 turns off and a valve 311, such as a three-way valve or two sets of butterfly valves or similar valves, switches the feed flow to an elution feed from pump 312. Once the adsorption cycle is complete, the elution pump feeds an elution fluid to the reactor(s) through pump 312, valve 311 into the column 301. The elution fluid typically contains an ion that acts in a manner of ion exchange to replace the lithium on the adsorbent. In the preferred embodiment, the elution fluid is a strong acid solution such as 0.2 to 0.7 molar hydrochloric acid. The hydrochloric acid is fed to the reactor(s) continuously recycling in the same manner as the adsorption phase. A plurality of elution cycles improves the recovery. In one embodiment, a minimum of 4 cycles is used to effectively exchange the lithium for the hydrogen ions in the elution fluid. A minimum 0.2 M hydrochloric acid provides sufficient driving force for the ion exchange while a maximum strength of 0.7 molar minimizes degradation of the preferred adsorbent-binder matrix. During elution, the pH of the elution fluid is maintained in the range of pH 0.8 and 2. As with adsorption, a chemical injection pump 315, with control tied to a pH meter 314, adds additional concentrated acid. The acid added may be in a stoichiometric ratio equivalent to the uptake of the protons in exchange for lithium. The lithium-loaded elution fluid can then be passed 230a out of the reactor for further handling in a processing system 230. If the elution fluid contains adsorbent, it may be directed through a separator 158 before the elution fluid is passed 230b to system 230. In the preferred embodiment no such separator is required due to the appropriate pairing of adsorbent particle size and reactor high-flow retention filter.

There may be one or more product streams exiting the reactors 148 leading ultimately to two or three final product streams: (I) a cleaned water stream; (II) a lithium chloride solution; and (III) possibly, an adsorbent stream where the adsorbent is not fully retained in reactors 148. Regardless, after the HSPW or HTPW has contact time with the adsorbent, a stream of cleaned water is obtained that is separated from the adsorbent and ends up in the clean water handling system 160. The cleaned water is either reusable 210 or handled as waste 220. For example, the cleaned water may be reprocessed for additional metal recovery, passed to additional water treatment for reuse as a resource, disposed of or discharged to the environment. In the case of high temperature treatment of geothermal water, the clean water may be blended with potable water for domestic use.

The recovered lithium may be stored, treated, handled as liquid or solid, as described further below.

The recovered exchange fluid, and more particularly, the lithium chloride contained therein, may be evaluated for commercial purity and may be shipped out directly or treated in various ways before shipment.

Purity may be compromised by additional metals that remain in the exchange fluid due to its highly reducing nature. When this occurs, the invention introduces a third treatment process 162 to remove the additional metals. In this process, the pH is neutralized 163 and the solution is oxidized with ozone or peroxide 164 which causes the additional metals to drop out as solids. Recoverable solids formed in this treatment stage can be removed 165 from the extract fluid through centripetal force, filtration or both. The solids 165a from this additional step typically contain valuable but non-target metals that may be stored separately in the product storage area 231, while the fluid 165b containing the original target metal with enhanced purity and is returned to product storage 231.

Following any extraction from the adsorbent and or additional purification as described above, the lithium will typically achieve a concentration of 0.4 to 1% by weight within the fluid. Lithium recovery from the original feed brine exceeds 75%, for example, if the feed contained 100 mg/L of Li, at least 75 mg/L are recovered in the preferred embodiment. Purity is at least 80% lithium chloride in water with no more than 20% as other cation salts. At the above noted concentrations for Li, this translates to 2.4% to 12% by weight as lithium chloride 0.4 to 2% Li and no more than 2.4% as other cation salts.

In most embodiments of this invention, market demands require additional concentration of the lithium chloride within the extraction fluid. Commercial purity is typically between 10% to 40% by weight. When this is required for commercial grade, the invention implements a process of concentration 166. In one embodiment of the invention, concentration 166 is achieved using mechanical vapor recompression, evaporation or separation. For example, common to projects in association with heavy oil extraction, a multi-effect evaporator may be used. As another example, separation as by a membrane desalination technology is used. One embodiment of membrane desalination utilizes membrane electrodialysis reversal such as those systems widely available from commercial manufacturers. In yet another embodiment, separation is achieved by chemical manipulation to produce a desired metal precipitate free from impurities.

As referenced above, the extraction fluid can be subjected to an additional chemical manipulation to produce a metal precipitate from the fluid thus achieving concentration and purity without distillation. In one embodiment of this invention, the manipulation is achieved by adding 168 a carbonate source such as sodium carbonate (also known as soda ash) in a stoichiometric ratio to precipitate the target metal as a carbonate 168. In another embodiment of this invention, a sulfate is added to produce a metal-sulfide precipitate. Stoichiometric control of this process is achieved by utilizing an equilibrium model such as LucidChem™ in a control system.

In embodiments of the invention that produce a precipitate, such as a lithium carbonate is separated 171 from the original exchange fluid using centripetal force, filtration or both.

### EXAMPLES

In an example, a range of HSPW feed salinities were treated. At the upper limit tested, feed contained high concentrations of silica and divalent ions (Table 2). The methods for treating this HSPW were to alter the pH depending on silica concentration. In cases, where silica is above 1000 mg/L, the pH is adjusted to 8 in the presence of 200 to 500 mg/L polyaluminum chloride (PAC1), starting the polymerization of silica and silica-based alkaline earth minerals. pH was adjusted using concentrated sulfuric acid injected into the feed as per the preferred embodiment. The pH adjusted feed was pumped to the RSL™ system to remove colloidal solids formed during the polymerization of the silica. Table 2 provides permeate results for the pre-treatment steps of the preferred embodiment. With minimal effort very high removal rates are achieved. In cases where silica is lower than 1000 mg/L, the pH is adjusted to above 10 using a base in the presence of 200 to 500 mg/L PACl, this assists in polymerization of silica but is also effective at removing calcium and magnesium as insoluble hydroxides.

TABLE 2
Example feed and permeate qualities from treatment
of wastewaters typical of unconventional oil.

| | | Low | Low | High | |
|---|---|---|---|---|---|
| | | Si | Si | Si | High Si |
| | | HSPW | HSPW | HSPW | HSPW |
| | UNITS | RAW | TREATED | Raw | Treated |
| Reactive Silica | mg/L | 70 | 22 | 9200 | 61 |
| Total Organic | mg/L | 660 | 180 | 4800 | 3200 |
| Carbon (C) | | | | | |
| Turbidity | NTU | 8.5 | 2.2 | NA | NA |
| Total Calcium (Ca) | mg/L | 100 | 46 | 180 | 40 |
| Total Magnesium | mg/L | <20 | <20 | <20 | <20 |
| (Mg) | | | | | |
| Total Sodium (Na) | mg/L | 5600 | 2300 | 20000 | 15000 |
| Total Potassium (K) | mg/L | 61 | 29 | 630 | 500 |
| Dissolved Chloride | mg/L | 7200 | 2700 | 19000 | 14000 |
| (Cl) | | | | | |
| Dissolved Sulfate | mg/L | 67 | 750 | <100 | Note 1 |
| (SO4) | | | | | |
| Alkalinity | mg/L | 1700 | 220 | 11000 | 380 |
| (Total as CaCO3) | | | | | |

Note 1:
Sulfate will increase if sulfuric acid is used to adjust the pH.

Following pre-treatment the resulting permeate becomes the feed for lithium recovery. Examples for each of HSPW and HTPW are provided in Table 3. In the case of the HSPW, the product was further concentrated 10× in order to achieve a predetermined commercial grade of LiCl above 20% w/w. Concentration being a straightforward removal of pure water, the HTPW example provides an indication of the product quality that can be achieved in a single lithium recovery system such as that from the preferred embodiment.

TABLE 3
An example of HSPW and HTPW feed and product LiCl solution
following pre-treatment and Li recovery using the preferred embodiment.

| | HSPW | HSPW | HTPW | HTPW Recovered |
|---|---|---|---|---|
| | Feed | Recovered Li | Feed | Li product |
| Elements | (mg/L) | product (mg/L)¹ | (mg/L) | (mg/L)² |
| Ba | 11 | 10 | 160 | 75 |
| Ca | 23000 | 5000 | 39000 | 16 |
| Cu | ND | 0.8 | 4.5 | 0.14 |
| Fe | ND | 200 | 1900 | Not detected (ND) |
| Pb | ND | 2 | 140 | 0.28 |
| Li | 71 | 35500 | 270 | 4280 |
| Mg | 2900 | 100 | ND | ND |
| Mn | 0.23 | ND | 1700 | ND |
| K | 4700 | 400 | 21000 | 9000 |
| Na | 58000 | 16500 | 71000 | 31000 |
| Sr | 890 | 400 | 620 | 47 |
| Zn | ND | ND | 670 | 3.3 |

Notes:
¹HSPW product was concentrated 10x following extraction as per the preferred embodiment.
²HTPW product was not concentrated, results are post elution brine ready for concentration or direct sale.

While a number of exemplary aspects and embodiments are discussed herein, those of skill in the art will recognize certain modifications, permutations, additions, and sub-combinations thereof.

1. A method of recovering lithium from energy process water, comprising: removing alkaline earth metals from the water to form a treated water; passing the treated water through a reactor column to contact the treated water with a titanium oxide molecular sieve to adsorb lithium ions in the molecular sieve; draining the treated water from the reactor column while the molecular sieve remains in the reactor column; eluting the lithium ions from the molecular sieve using a strong acid solution to desorb the lithium ions into an eluate fluid; and collecting the eluate fluid from the reactor column, the eluate fluid being rich with lithium ions.

2. The method of claim 1, wherein the water is at a temperature less than 100° C. and the titanium oxide molecular sieve includes pellets of titanium oxide in a polyacrylamide matrix and the reactor column includes an outlet screen with a passage size smaller than the pellets.

3. The method of claim 1, wherein the water is at a temperature more than 100° C. and the titanium oxide molecular sieve includes pellets of titanium oxide in a zeolite or aerogel matrix and the reactor column includes an outlet screen with a passage size smaller than the pellets.

4. The method of claim 1, wherein removing includes initially treating to remove hydrocarbons by froth flotation.

5. The method of claim 1, wherein removing alkaline earth metals comprises precipitating alkaline earth metals ions and filtering the precipitate by replaceable skin layer membrane filtration to obtain the treated water.

6. The method of claim 5, wherein removing hydrocarbons occurs before precipitating.

7. The method of claim 6, wherein the energy process water is produced water from oil and gas operations.

8. The method of claim 1 wherein the energy process water is thermal energy process water and the water has a temperature greater than 100° C.

9. An apparatus for recovering lithium from energy process water, comprising:
a system for removing alkaline earth metals from the water to form a treated water;
a reactor for removing the lithium ions from the treated water, the reactor including at least one column, the column including:
an inlet;
an outlet;
a diffuser core at the inlet through which fluid flows from the inlet into an inner volume of the column, the diffuser core tapered from a wider base to a narrow inner end and the diffuser core including a first screen through which the fluid flows;
an outlet tube at the outlet through which fluid exits the inner volume of the column, the outlet tube including a mounted end, a narrower tip and walls that taper from the mounted end to the narrower tip, the walls including a second screen through which the fluid flows; and
a titanium oxide molecular sieve configured to adsorb lithium ions, the titanium oxide molecular sieve retained in the inner volume between the diffuser core and the outlet tube and having a size unable to pass through the second screen;
an eluting system configured to contact the molecular sieve with a strong acid solution to desorb lithium ions into an eluate fluid; and
a collecting system to collect the eluate fluid, the eluate fluid being rich with lithium ions.

10. The apparatus of claim 9, wherein the titanium oxide molecular sieve includes pellets of titanium oxide in a polyacrylamide matrix and the second screen has a passage size smaller than the pellets.

11. The apparatus of claim 9, wherein the titanium oxide molecular sieve includes pellets of titanium oxide in a zeolite or aerogel matrix and the second screen has a passage size smaller than the pellets.

12. The apparatus of claim 9, wherein the system for removing alkaline earth metals includes a replaceable skin layer membrane filtration unit to remove a precipitate of the alkaline earth metals.

13. The apparatus of claim 12, further comprising upstream of the system for removing alkaline earth metals, a froth flotation apparatus configured for removal of hydrocarbons.
